(19) United States
(12) Patent Application Publication
(10) Pub. No.: US 2014/0274307 A1
(43) Pub. Date: Sep. 18, 2014

(54) SYSTEM AND METHOD FOR PROVIDING VIRTUAL WORLD REWARD IN RESPONSE TO THE USER ACCEPTING AND/OR RESPONDING TO AN ADVERTISEMENT FOR A REAL WORLD PRODUCT RECEIVED IN THE VIRTUAL WORLD

(71) Applicant: BRAINZ SAS, Bogota (CO)

(72) Inventor: Alejandro GONZALEZ, Bogota (CO)

(73) Assignee: Brainz SAS, Bogota (CO)

(21) Appl. No.: 13/800,469

(22) Filed: Mar. 13, 2013

(51) Int. Cl. A63F 13/00

(52) U.S. Cl. CPC A63F 13/00
USPC 463/25

(57) ABSTRACT

A virtual world reward redemption system and method are disclosed which may comprise a user computing device displaying a virtual world interactive video game environment, including, e.g., a display of a video game, with, e.g., a prompt to the user indicating the availability of a virtual game item to the user as a reward for the user taking an action in the real world of the user with respect to at least one of purchasing the product or the performance of the service. A user interface may verify the taking of the action by the user through the capture of a video feed using the user computing device of a proof of purchase item and the computing device may receive confirmation of the user performing the action of the user in the real world of the user in the form of a redemption of the virtual game item.

### BACKGROUND OF THE INVENTION

User computing devices are well known to be able to be utilized to allow a user to play a game, such as a video game, in a virtual world environment of the game displayed on the display of the user computing device. Such a user computing device may include a hand held computing device, e.g., as part of a user mobile communication device, such as an iPhone™, iPad™, cellular phone, personal digital assistant (“PDA”), such as a Blackberry™, etc. Such a game may be a role playing game (“RPG”), an arcade/action type game or combination of the two, an electronic version of a board game, a gambling/card game, a sports game or the like, referred to collectively in the present application as a role playing game. During the play of such a game, the user may have a need to or wish to obtain some form of virtual item relating to the game. As an example, in a role playing game, the character or party controlled by the user or by or with other users, e.g., in multi-party video games where other users are linked through the Internet to the play of the video game, may gather or purchase items such as armor and weapons, magic objects, and may build up virtual game currency, such as gold or silver coins, with which to trade for or purchase such virtual game items. The user or user's party may also improve the character's or party's offensive and defensive capabilities, such as life level, strength, agility etc.

Provision of advertisements to users over user computing devices is also well known. This can include over mobile devices of the user. The advertisements may be focused and targeted to the specific user, e.g., based on a user profile obtained from the user, usually voluntarily, in an enrollment process, e.g., when the user logs in to the particular video game for the first time. Also information obtained about the user, e.g., from location determining algorithms associated with the user's use of the mobile device, e.g., utilizing GPS or signal triangulation or the like, may also be part of the targeting of the advertisements. Information may be gathered, e.g., from recent uses of the user device, e.g., the conduct of a key word or topic search on a network, e.g, the Internet using the user computing device, the purchase of a product or the performance of a service using the user computing device, e.g., a mobile user computing device interacting with a point of sale (“POS”) device, or through a social network, e.g., LinkedIn or Facebook or the like, such as checking in and/or liking a particular merchant establishment. Other information may also be transferrable, often with user permission, from data collected regarding past purchases, e.g., by a credit account token (credit card) provider financial institution or consumer credit system manager, and including associated customer loyalty programs, or other social network database information relating to the user, etc. In any event, the environment of the collection and use of such information for the provision of an advertisement, particularly a highly focused advertisement, to users over user computing devices, and more particularly over mobile user computing devices is well known.

Advertisements have appeared within mobile applications and games that promote other digital applications and services rather than physical consumer products or actual provision of a service to the user in the user's real world, e.g., a tire rotation or oil change or the like. Part of the obstacle to doing so is the difficulty in tying the purchase of the product or performance of the service to the return of the advertiser or advertising service provider through the play of the game on the user's computing device. While consumer products and services, e.g., branded products and services have traditionally reached their customers thorough diverse screens (TV, Web, Mobile) to advertise their products and services. Mobile is rapidly becoming the most used screen for consuming digital content and this consumption is essentially done through running of applications remotely hosted or downloaded entirely or in part to the user computing device, such as the mobile user device. Most of the advertisement space within such applications on the user computing device are directed to other applications, e.g., other games, whereby, e.g., the revenue is split between the application provider and a digital subscription service like NETFLIX, both of which have a direct correlation between advertising spending and their sales, since they are mainly driven by user acquisition and are monetized digitally, thereby, minimizing a consumer brand's opportunity to exploit the screen of the user computing device. The disclosed subject matter provides improved functionalities in the interface of such video games and targeted advertisement systems and methods.

### SUMMARY OF THE DISCLOSED SUBJECT MATTER

A virtual world reward redemption system and method are disclosed which may comprise a user computing device configured to display a virtual world interactive video game environment, the virtual world interactive video game environment including a display of a video game, the display of the video game including a prompt to the user indicating the availability of a virtual game item to the user as a reward for the user taking an action in the real world of the user with respect to at least one of purchasing a product or the performance of a service; a user interface configured for the user to verify the taking of the action by the user in the real world of the user through the user capturing a photograph of or a video feed of a proof of purchase item or the system using the camera feed into the computing device to capture vide or a frame of video and transmitting the photograph or frame(s) through the user computing device; and the user computing device configured to receive confirmation of the user performing the action of the user in the real world of the user in the form of a redemption of the virtual game item. The system, e.g., at a remote server may analyze the video, including a frame or frames of the video to detect objects or shapes or the like in the frame indicating the user has made a purchase of and/or possesses an advertised product.

The system and method may further comprise the user computing device comprising a hand held user computing device. The system and method may further comprise the video game comprising a role playing game. The prompt may indicate to the user at least one of the virtual game item and the action to be taken by the user in the real world of the user. The user interface may comprise the computing device's video hardware, such as, camera hardware, e.g., a digital camera unit contained on a hand held user computing device.

The virtual world reward redemption system and method may comprise the action in the real world of the user comprising the user, without a prompt, selecting at least one of viewing an advertisement for one of the purchase of a product or of the performance of a service, or the purchase of the product or the performance of the service and the user computing device configured to verify the user taking an action with respect to the user selected product or user selected performance of a service. The user computing device may be configured to utilize a video recognition algorithm for the confirmation of the user performing the action of the user in the real world of the user.

Also disclosed is a machine readable medium storing instructions that, when executed on a computing device cause the computing device to perform a method, which may comprise displaying a virtual world interactive video game environment, the virtual world interactive video game environment including a display of a video game; providing a prompt to the user within the display of the video game environment indicating the availability of a virtual game item to the user as a reward for the user taking an action in the real world of the user with respect to at least one of purchasing a product or the performance of a service; verifying the user taking of the action in the real world of the user through the capture of a video image of a proof of purchase item and transmitting the video image through the user computing device; and receiving confirmation of the user performing the action of the user in the real world of the user in the form of a redemption of the virtual game item.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows a partially schematic and partially block diagram illustration of an embodiment according to aspects of the disclosed subject matter;

FIGS. 2A-D show partly schematic views of screen displays according to aspects of embodiments of the disclosed subject matter;

FIGS. 3A-E show partly schematic views of screen displays according to aspects of embodiments of the disclosed subject matter;

FIGS. 4A-F show partly schematic views of screen displays according to aspects of embodiments of the disclosed subject matter;

FIGS. 4A-F show partly schematic views of screen displays according to aspects of embodiments of the disclosed subject matter;

FIGS. 5A and 5B show partly schematic views of screen displays according to aspects of embodiments of the disclosed subject matter;

FIGS. 6A and 6B show partly schematic views of screen displays according to aspects of embodiments of the disclosed subject matter;

FIG. 7A-D show partly schematic views of screen displays according to aspects of embodiments of the disclosed subject matter;

FIG. 8 shows a partly schematic view of a screen display according to aspects of embodiments of the disclosed subject matter; and

FIG. 9 shows a partly schematic view of a screen display according to aspects of embodiments of the disclosed subject matter.

### DETAILED DESCRIPTION OF THE INVENTION

According to aspects of preferred embodiments of the disclosed subject matter, a system and method are disclosed. The disclosed subject matter may include a system and method useable by a user of a user computing device, e.g., a mobile computing device, such as a I-PAD™, I-Phone™, Blackberry™, personal digital assistant (“PDA”), cell phone, or other computing device, whether mobile or not, e.g., including a home computer or laptop equipped, smart television, cable set top box, or the like, that is equipped with a camera input device. The computing device may be capable of utilizing various applications, such as, internet based applications, software as a service based applications, downloadable applications and other applications hosted or partly hosted on the user computing device.

Such an application may be a game accessible over the network or downloaded or partly downloaded to the user's computing device, as an example a “role playing” game (“RPG”), an arcade style “action” game, e.g., a “pinball” game in one of its many variations, a hybrid game, e.g., involving aspects of an RPG and an arcade “action” game, a sports game, such as EAG's baseball or football games, an electronic version of a board game, a gambling or card game, an electronic version of a popular television game show, a simulation game, such as a city builder or nation builder game, a quiz game, or the like kinds of digital virtual world games played on a computing device and using a computing device display. According to aspects of embodiments of the disclosed subject matter, as is well understood in the art, each of these types of video games can have some form of virtual “currency” involved with the playing of the game by the user. As examples, in a pinball game the “virtual currency” may include the increase of the player's score, e.g., for the grant of award points needed for, e.g., the purchase of an extra ball, an increase in some or all of the values of the pinball targets, etc. In other games extra turns, or doing over a prior turn, or replenishment of some or all of the user's stake in a gambling game, return to life of a vanquished user character or party member, a re-deal of the cards, access to a locked or blocked area or level of the game or to another application, such as another game previously inaccessible or unavailable to the user, etc. are all considered for purposes of the present application as “virtual game items.”

In the example of the role playing game, the virtual currency, e.g., the gold or silver coins, can be utilized by the user to purchase certain virtual items, e.g., a weapon, some armor, a magic spell, a magic amulet, a magical upgrade of another magical item, e.g., a weapon, or piece of armor, an increase in character experience points, maps or directions, the ability to add another character to the party of the user, etc. (collectively, as noted above, in the present application and accompanying claims referred to as “virtual game items”). It will also be understood that the ability to obtain any of these “virtual game items” directly, without going through the intermediate step of obtaining the game currency, e.g., in coins, as an example, and purchasing the item according to the game environment rules for allowing such use of the coins, may also be made possible and is considered to be the obtaining of a “virtual game item,” for purposes of the present application.

Turning now to FIG. 1 there is shown partially schematically and in partial block diagram format an example of an embodiment of the disclosed subject matter. In FIG. 1 a process 20 according to the disclosed subject matter can be seen to include a user computing device 22, such as a mobile computing device, having a display screen 24 on which can appear a display 26. According to aspects of embodiments of the disclosed subject matter, an application can be activated on the user computing device 22 which can then prompt a server 30 for information and data, e.g., including software for control the application, such as a video game.

The server 30 can search a database (not shown) which is part of and/or local to the server, or remotely accessed, e.g., over a network, such as the Internet. The database can be searched to determine if there is any available advertisement campaign applicable to the user and/or to the application being played on the user's computing device. Such may be targeted to the specific user and also ordinarily to the specific user playing the specific video game, as the advertisement campaign may be focused for products and/or services determined by the advertiser or the advertising publisher to be likely to excite the interest of the user for products or services connected with an available campaign, and also because ordinarily the rewards are tied to virtual game items specific to the game. The server 30 may also act according to a determination of such factors as, e.g., the physical location of the user, e.g., determined by the location of the users mobile communication device and the availability for reward prizes at the time.

Generally speaking a reward or list (or so called “wall”) of rewards may then be presented to the user. The reward or list may be presented, e.g., in the form of a banner or interstitial advertisement, e.g., before, during or after the user plays the game, e.g., based on the most recently played game on the user's computing device. The advertisement can be caused to appear in a game that has the system and method of the disclosed subject matter enabled in some way, e.g., the game manufacturer is a publisher of advertisements or is operating together with an advertiser or publisher of advertisements. This could also occur, e.g., during a natural pause of the game where the advertisement and reward information is relevant. The advertisement may be displayed in the form of a shop for the purchase of virtual game items, and may, as an example, correspond to the user in the play of the video game being in such a shop, e.g., a wizard's shop purchasing magic items. The offer may then be represented by the opportunity to obtain such a virtual game item or virtual game items in the form of game currency for use in purchasing the virtual game item at the wizard's shop while playing the game. The virtual good shop could also be displayed when the game is not being played allowing the user to purchase a virtual game item for use when the game is being played or virtual game currency. The user may select from a virtual game item or a list of virtual game items.

When the user selects an offer, the camera view can be activated, e.g., with the viewfinder shown on the screen. The user can then be prompted, e.g., to show a package of the consumer produce or other proof of purchase offering, e.g., by the taking of a picture of the box in which the product was purchased. The server 30 can receive the video feed or at least a frame or frames from the video feed and process the data in the video feed, e.g., with image recognition and tracking software, as is well known in the art, and determine that the photograph is of a package containing the applicable product. The picture data may also contain other product identification information, e.g., a universal product identifier, e.g., in the form of a bar code readable by the server 30, identifying, e.g., not only the brand of the product, but, e.g., the specific instantiation of the product. In that way, as an example, the user may not use that particular proof of purchase to subsequently claim a similar reward for the subsequent purchasing of the consumer product.

When the packaging is so detected and validated, a message may be sent by the server 30 to the user's computing device 22 that the server 30 has validated and then log in the user as a winner of the reward. The server 30 and/or the user's computing device and/or the two together can then provide the virtual game item to the user within the context of the user playing the game or next opening the application to play the game. Upon such validation, an indication to the user may be provided, e.g., a special sound may be played on the user's computing device and/or some visual effect, e.g., rendered on the picture of the consumer brand product appearing on the display of the user's computing device, e.g., simulated sparks or bubbles can be utilized to indicate to the user that the user has been granted the reward of the virtual game item.

After this, according to one embodiment of the disclosed subject matter, the video game application can go back to its previous state. Also, e.g., in lieu of the display of the previous offer a timer can be displayed which can prompt the user to an ability to claim a new reward or the same reward by proof of purchase of the same consumer brand product or a different consumer brand product using that Consumer Brand's package, including, e.g., also a time limit for the user to wait before such new reward is made available. Validating the package of the product and/or other proof of purchase may utilize, e.g., natural feature tracking, e.g., analyzing the picture data to match a particular element(s) in that packaging's artwork with stored artwork, and perhaps also other coded information, such as bar codes and the like. Other forms of well known validating technologies may also be employed to avoid user fraud on the system, such as the server 30 providing a coded challenge unique to the transaction and the user's communication device responding to the unique coded challenge with a similarly unique response to the server 30, thus limiting the exchange between the server 30 and the user computing device 22 to a single exchange for each given reward of a virtual game item.

According to aspects of embodiments of the disclosed subject matter, there may also be utilized other redemption actions. As an example, after validating the product, and prior to awarding the prize, the server 30 may communicate to the computing device of the user a prompt for the user to complete some other activity within the real world of the user. As an example, the user may be prompted, through the computing device of the user to visit another destination site, e.g., a merchant location, or open another application, which may also be in the form of an advertisement focused and targeted to the particular user, his or her location, etc. The user may similarly be required to perform some form of a registration, such as “checking in” on Facebook™ or logging in to a web-site, or other action, such as, “liking” a location or a web-site or page in a social network.

Turning now to FIGS. 2A-2D there is illustrated partly schematically a mobile communication/computing device, such as an I-Phone 22 having a display screen 24 and a user interface ribbon, containing, e.g., a get-more-coins button 30, a shop button 32, a level indicator 34, e.g., to indicate the level of the game and/or the level of the character controlled in the game by the user of the mobile communication/computing device 22. The interface ribbon also has a “settings” button 36 for adjusting settings on the mobile communications/computing device 22.

If the user selects the “Get more Coins” option on the screen display of FIG. 2A, by touching the button 30, which can also indicate the number of coins or other game currency that the user already possesses, e.g., 1250, and that this can be increased with the function associated with the button 30 (i.e., the “+” sign), the display will change to that shown in FIG. 2B. There the user can partake of several options, e.g., coin packages, such as option 40, 100 coins for $0.99, option 42, 300 coins for $1.99 and option 44, 1000 coins for $4.99. Also displayed can be a touch selection option button 48 for selecting an advertisement for the purchase and use of a consumer brand product, a fictional soft drink “Frost,” i.e., “Drink ‘Frost’ and get 500 FREE COINS.”

If the user selects this option button 48, then the user computing device causes the screen display to change to the view finder of the camera on the user's mobile communications/computing device. The computing device with its camera activated can then capture a video stream, e.g., of the user putting the product package in front of the camera, and the video feed including the consumer brand product package, e.g., as illustrated in FIG. 7C. The user may then close the camera interface, e.g., by touching the “close” button 50 or the close button may be used to close the video feed function is the user has nothing to capture a video of using the camera. Validation by the server 30, the user computing device 20, or both in cooperation, redeems the reward for the user, e.g., by adding the 500 coins to the user's coin total, as discussed in more detail below. The bottom option location 46 of FIG. 2B may then be changed by the server 30 or the computing device 22 to indicate the time, e.g., in minutes and seconds, until the same or a similar advertisement and reward offer will be renewed as an option to the user in option selection 48.

Turning now to FIGS. 3A-E there is illustrated a virtual game item wall of offers, where the screen display in FIG. 3A is the same as in FIG. 2A and the second screen display in FIG. 3B is similar to that in FIG. 2A, but with the bottom button 60 simply offering “FREE COINS. In response to the user selection of the offer button 60 produce the server 30, the user computing device 20, or both in cooperation, cause the display of FIG. 3C wherein the user is given options 62, 64, 66 and 68 to respond to the advertisements shown to purchase and to drink one of several different beverage products and to be rewarded with various amounts of virtual game currency, such as numbers of coins, accordingly. Touching the “Close” button 50, as before, returns the offer selection button “wall” to the display screen 24 with the button selection option button indicating the time to the next offer being activated. In this case, according to aspects of embodiments of the disclosed subject matter, the other offers for purchase and partaking of the other different products or services, can still be selected by the user.

Turning now to FIG. 4A-F there is illustrated schematically a user interface to obtain virtual game items in the form of items of use to the player of the video game within the play of the video game. FIG. 4A is essentially the same as FIGS. 2A and 3A. When the user is presented with the opportunity to purchase virtual game items in the form of virtual goods useful in playing the game, such as a castle, option button 80, some armor, option button 82 or a “super sword,” e.g., with some magical powers, option button 84, the user may also be presented with an option button 86 to get other forms of free virtual goods, option button 86 “FREE STUFF.”. This may occur where the character of the user is in a place in the video game where such purchasing of virtual goods is possible during the game play, or by the user pressing the “Shop” button 32. The user may then be presented with a “wall of offers, for virtual goods, such as option selection buttons 90, “FREE Armor,” e.g., associated with drinking “Product 1,” 92, “FREE CASTLE,” associated with the drinking of Product 2, 94, FREESWORD, associated with the drinking of “Product 3,” and 96, FREE SPEAR, associated with the drinking of Product 4. The user then select one of the option selection buttons 90, 92, 94 or 96 and interfaces with the server 30 or the communications/computing device 22 or both in cooperation, as noted above to verify the purchase of the particular one of the products in the real world and is rewarded, as noted above, for such purchase with the virtual game item in the virtual world of the video game. As shown in FIG. 4D, if the user finishes with the delivery in the virtual world of the virtual game item associated with one of the option selection buttons 90, 92, 94 or 96, e.g., 96, then the “FREE STUFF” option selection button may be gone. This may also be replaced by a time-to-new-offer indication as discussed above. The user may then purchase a virtual item in the video game using the appropriate amount of virtual game currency, until the “FREE STUFF” button reappears and then select one of the other free virtual game items 90, 92 or 94 from the free item wall shown in FIG. 4F.

Turning now to FIG. 5A there is shown partly schematically that the user may be presented with a banner advertisement 100, e.g., “Drink Frost and claim a sword,” or like virtual good for user in the virtual environment of the video game. This may occur before the video game begins, during a pause in or interruption of the video game or after the user completes playing the video game for the time being. Clicking on the banner add 100 has essentially the same effect of clicking on an offer option selection button as noted above as to the utilization of the camera on the user communication/computing device, as illustrated in FIG. 5B, to verify the purchase and obtain the reward of the virtual game item.

Turning now to FIG. 6A, there is illustrated partly schematically in instance of the user being presented with an interstitial offer, e.g., during the playing of the video game, e.g., the user may have selected to purchase or otherwise obtain a virtual game item in the game, at sole cost in some game currency, and the server, the user communications/computing device or both together may change the display, e.g., while pausing the game play, and present the offer to the user to “DRING FROST and claim a new SWORD.” As indicated in FIG. 6B, the user can, as explained above, verify the purchase of the product “FROST” using the camera and claim the reward of the virtual game item and the user is returned to the play of the video game.

Turning now to FIGS. 7A-7D there is illustrated partly schematically screen displays 150 from a video game, e.g., of the hybrid RPG and action types, e.g., in the form of a sports game, such as the soon to be marketed game “SOCIAL STREET SOCCER,” a product of the assignee of the present application. The screen shot of FIG. 7A illustrates basically the virtual environment 160 of the game, a street soccer playing field in an urban setting. The user can control a team, e.g., of several soccer players 180 and can select a variety of versions of the game to play, e.g., “RULE THE CITY,” 190, “CHALLENGE,” 192 and “PLAY FOR CASH” 194. As part of the screen display 150, the user may have the opportunity to select the “get more cash” button 224, displayed, e.g., with an indication of the user's team's current supply of cash 226, and perhaps some other indication of the capabilities of the user's team such as experience level 226. The display 150 may indicate an energy level 240 and an experience level 242 of the user's team. Also an indication 200 may be displayed that the user can invite friends to play the video game, and provide a link, e.g., to a social cite or email application, etc. to allow the user to do so. Other attributes of game play 244, 246 may also be displayed on the top ribbon, along with a designation 250 that the current display if of the user's team and a designation 260.

By selecting the button 224, the user may, e.g., be presented with a scrolling display, 280, e.g., as shown in FIG. 7B, in a substituted screen display 284, e.g., not showing the game or the team, etc. The scrolling display 290 may show a number of possible purchases that the user can make of virtual game items, using the existing supply of game currency in cash, or may select to get free coins with the option selection button 296, shown in FIG. 7B. As noted above, the screen display can then shift to the view finder of the camera as shown in FIG. 7C and the user can take a picture of the “Frost” box 292, which can include the user simply placing the “Frost” box in front of the camera to provide a video feed and by analyzing the camera feed, e.g., at the server of the advertisement provider, using, e.g., a natural feature tracking algorithm the packaging may be identified, e.g., through the proof of purchase item on the packaging, as the advertised product. The display may then indicate that the product has been recognized as the qualifying product, e.g., by showing a glow effect on top of the box with a sound that tells the user that the verification was successful. After the additional coins are obtained, the scrolled display may contain a selection button 296 indicating the time until more free coins will be made available.

FIG. 8 illustrates a screen display 24 with a banner add 300 appearing when no application is running on the communications/computing device 22 of the user. This can be related to a particular application of game that can be run on the communication/computing device 22 of the user, and the user may provide proof of purchase in the real world, and receive credit for the reward in the form of the virtual game item, but the server 30 or the communications/computing device of the user or both may store the information indicating that the user has attained the reward virtual game item, until the user reopens that particular application on the communications/computing device of the user an then register the award within the playing of the video game in the virtual game environment. In accordance with aspects of an embodiment of the disclosed subject matter, the user may be given access to a previously inaccessible application or to a previously inaccessible feature of an application, web-site or page or other internet location or the ability to carry out certain activities, such as, browsing or searching, for free, unlocking other features, including advanced features, of an application previously locked or otherwise inaccessible to the user, or like versions of “virtual game items.”

Similarly, as shown in FIG. 9 an interstitial advertisement 330 may be displayed on the communications/computing device display screen 24, such as a home page, along with icons 320 and 322. This advertisement may also be associated with a particular application or video game that the user has on the communications/computing device and processed as discussed above in regard to the banner advertisement of FIG. 8.

It will be understood by those skilled in the art that the disclosed subject matter in the present application discloses a virtual world reward redemption system and method which may comprise a user computing device configured to display a virtual world interactive video game environment, the virtual world interactive video game environment including a display, e.g., of a video game, the display of the video game including a prompt to the user, such as a virtual game item selection option button display, or a banner advertisement or interstitial advertisement, indicating the availability of a virtual game item to the user as a reward for the user taking an action in the real world of the user with respect to at least one of purchasing a product or a performance of a service; a user interface configured for the user to verify the taking of the action by the user in the real world of the user through capturing a video feed of a proof of purchase item identifying the product or the service purchased; and the user computing device configured to receive confirmation of the user performing the action of the user in the real world of the user in the form of a redemption of the virtual game item.

The system and method may further comprise the user computing device comprising a computing device equipped with a camera input device, such as a hand held user computing device, e.g., an iPhone, iPad, personal digital assistant (“PDA”), such as a Blackberry, cell phone, home or lap top or palm top computer, or the like. The system and method may further comprise the video game comprising a role playing game, such as a purely role playing game, an arcade game, a hybrid of an RPG and arcade game, a sports game, a board game, a gambling or card playing game, a simulation of a television program, such as a game show, etc. The prompt may indicate to the user at least one of the virtual game item and the action to be taken by the user in the real world of the user.

The action to be taken by the user in the real world of the user may comprise the purchase of at least one of a product or the provision of a service or a combination of these. Other actions in the real world may be prompted to the user and rewarded as well, e.g., viewing the advertisement and/or going to a particular merchant's place of business, or to a mall or shopping center, making a reservation for, e.g., dinner or a plane ticket or theater performance, etc.

The virtual world reward redemption system and method may comprise the action in the real world of the user comprising the user, without a prompt, selecting a location on the communications/computing device of the user where the user can go to enter a proposed exchange of real world performance for a virtual game item. This could include a place to search for advertisers or advertising publishers that have pending campaigns relating to the video game(s) or other virtual game environments or the like displayable on the user's communications/computing device.

The search could involve searching for an advertiser or advertisement publisher offering for free a special video game virtual item that the user desires, e.g., a special magic spell, or potion, a weapon of armor enhanced with a particularly potent magic, etc. The user computing device may be configured to utilize a video recognition algorithm for the confirmation of the user performing the action of the user in the real world of the user.

Also disclosed is a machine readable medium storing instructions that, when executed on a computing device cause the computing device to perform a method, which may comprise displaying a virtual world interactive video game environment, the virtual world interactive video game environment including a display of a video game; providing a prompt to the user within the display of the video game environment indicating the availability of a virtual game item to the user as a reward for the user taking an action in the real world of the user with respect to at least one of purchasing a product or the performance of a service; verifying the user taking of the action in the real world of the user through the user capturing, e.g., photographing or creating a video feed of a proof of purchase item presented by the user; and receiving confirmation of the user performing the action of the user in the real world of the user in the form of a redemption of the virtual game item. It will also be understood by those skilled in the art that the proof of purchase item may include a wide variety of forms, such as, by way of example, a particular design contained on the product, or on an invoice for the purchase of a service, including, as examples, also text and a “paid” stamp, e.g., bearing a date and perhaps even a time, a product name included on the package or invoice or the like, that is sufficiently distinctly rendered as to identify the name as appearing on a package in which the product is contained or in an invoice for the service, a bar code, one dimensional or two dimensional, or other coded symbol, such as a universal product identifier, contained on the package or the invoice, a token provided with the package or the provision of a service, with a recognizable and imagable shape, text, code or number, a coded message or challenge or challenge response recognizable at the advertising provider server, and like ways to verify through the video fee, an image frame or frames in the video feed, etc. that the user is entitled to the reward in the virtual environment, etc.

The following is a disclosure by way of example of a computing device which may be used with the presently disclosed subject matter. The description of the various components of a computing device is not intended to represent any particular architecture or manner of interconnecting the components. Other systems that have fewer or more components may also be used with the disclosed subject matter. A communication device may constitute a form of a computing device and may at least include, contain utilize or emulate a computing device. The computing device may include an interconnect (e.g., bus and system core logic), which can interconnect such components of a computing device to a data processing device, such as a processor(s) or a microprocessor(s) or a controller(s), or other form of partly or completely programmable or pre-programmed device, e.g., hard wired and/or application specific integrated circuit (“ASIC”) customized logic circuitry, such as may implement, e.g., a controller or microcontroller, a digital signal processor, or any other form of device that can fetch and perform instructions, operate on pre-loaded/pre-programmed instructions, and/or follow instructions found in hard-wired or customized circuitry, such as above noted forms of hard-wired circuitry containing logic circuitry, in order to carry out logic operations that, together, perform steps of and whole processes and functionalities as described in the present disclosure.

In this description, various functions, functionalities and/or operations may be described as being performed by or caused by software program code to simplify description. However, those skilled in the art will recognize that what is meant by such expressions is that the functions resulting from execution of the program code/instructions are performed by a computing device as described above, e.g., including a processor, such as a microprocessor, microcontroller, logic circuit or the like noted above. Alternatively, or in combination, the functions and operations can be implemented using special purpose circuitry, with or without software instructions, such as using an Application-Specific Integrated Circuit(s) (ASIC) or a Field-Programmable Gate Array(s) (FPGA), which may be programmable, partly programmable or hard wired. The application specific integrated circuit (“ASIC”) logic may be such as gate arrays or standard cells, or the like, implementing customized logic by metalization(s) interconnects of the base gate array ASIC architecture or selecting and providing metalization(s) interconnects between standard cell functional blocks included in a manufacturer's library of functional blocks, etc. Embodiments can thus be implemented using hardwired circuitry without program software code/instructions, or in combination with circuitry using programmed software code/instructions.

Thus, the techniques are limited neither to any specific combination of hardware circuitry and software, nor to any particular tangible source for the instructions executed by the data processor(s) within the computing device, such as a tangible machine readable medium. In other words, as an example only, part or all of the machine readable medium may in part or in full form a part of the, or be included within the computing device itself, e.g., as the above noted hard wiring or pre-programmed instructions in any memory utilized by or in the computing device.

While some embodiments can be implemented in fully functioning computers and computer systems, various embodiments are capable of being distributed as a computing device including, e.g., a variety of architecture(s), form(s) or component(s). Embodiments may be capable of being applied regardless of the particular type of machine or tangible machine/computer readable media used to actually effect the performance of the functions and operations and/or the distribution of the performance of the functions, functionalities and/or operations.

The interconnect may connect the data processing device to defined logic circuitry including, e.g., a memory. The interconnect may be internal to the data processing device, such as coupling a microprocessor to on-board cache memory, or external (to the microprocessor) memory such as main memory, or a disk drive, or external to the computing device, such as a remote memory, a disc farm or other mass storage device(s), etc. Commercially available microprocessors, one or more of which could be a computing device or part of a computing device, include a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc, or a 68xxx series microprocessor from Motorola Corporation as examples.

The inter-connect in addition to interconnecting such as microprocessor(s) and memory may also interconnect such elements to a display controller and/or display device, and/or to other peripheral devices such as an input/output (I/O) device(s), e.g., through an input/output controller(s). Typical I/O devices can include a mouse, a keyboard(s), a modem(s), a network interface(s), a printer(s), a scanner(s), a digital or video camera(s) and other devices which are well known in the art. The interconnect may include one or more buses connected to one another through various forms of a bridge(s), a controller(s) and/or an adapter(s). In one embodiment an I/O controller may include a USB (Universal Serial Bus) adapter for controlling a USB peripheral(s), and/or an IEEE-1394 bus adapter for controlling an IEEE-1394 peripheral(s).

The storage device, i.e., memory may include any tangible machine readable media, which may include but are not limited to recordable and non-recordable type media such as a volatile or non-volatile memory device(s), such as volatile RAM (Random Access Memory), typically implemented as a dynamic RAM (DRAM) which requires power continually in order to refresh or maintain the data in the memory, and a non-volatile ROM (Read Only Memory), and other types of non-volatile memory, such as a hard drive, flash memory, detachable memory stick, etc. Non-volatile memory typically may include a magnetic hard drive, a magnetic optical drive, or an optical drive (e.g., a DVD RAM, a CD ROM, a DVD or a CD), or other type of memory system which maintains data even after power is removed from the system.

A server could be made up of one or more computing devices. A server can be utilized, e.g., in a network to host a network database, compute necessary variables and information from information in the database(s), store and recover information from the database(s), track information and variables, provide interfaces for uploading and downloading information and variables, and/or sort or otherwise manipulate information and data from the database(s). In one embodiment a server can be used in conjunction with another computing device(s) positioned locally or remotely to execute instructions, e.g., to perform certain algorithms, calculations and other functions as may be included in the operation of the system(s) and method(s) of the disclosed subject matter, as disclosed in the present application.

At least some aspects of the disclosed subject matter can be embodied, at least in part, in programmed software code/instructions. That is, the functions, functionalities and/or operations and techniques may be carried out in a computing device or other data processing system in response to its processor, such as a microprocessor, executing sequences of instructions contained in a memory or memories, such as ROM, volatile RAM, non-volatile memory, cache or a remote storage device. In general, the routines executed to implement the embodiments of the disclosed subject matter may be implemented as part of an operating system or a specific application, component, program, object, module or sequence of instructions usually referred to as a “computer program(s),” or “software.” The computer program(s) typically comprise instructions stored at various times in various tangible memory and storage devices, e.g., in a computing device, such as in cache memory, main memory, internal disk drives, and/or above noted forms of external memory, such as remote storage devices, such as a disc farm, remote memory or databases, e.g., accessed over a network, such as the Internet. When read and executed by a computing device, e.g., by a processor(s) in the computing device, the computer program causes the computing device to perform a method(s), e.g., process and operation steps to execute an element(s) as part of some aspect(s) of the system(s) or method(s) of the disclosed subject matter.

A tangible machine readable medium can be used to store software and data that, when executed by a computing device, causes the computing device to perform a method(s) as may be recited in one or more accompanying claims defining the disclosed subject matter. The tangible machine readable medium may include storage of the executable software program code/instructions and data in various tangible locations as noted above. Further, the program software code/instructions can be obtained from remote storage, including, e.g., through centralized servers or peer to peer networks and the like. Different portions of the software program code/instructions and data can be obtained at different times and in different communication sessions or in a same communication session, e.g., with one or many storage locations.

The software program code/instructions and data can be obtained in their entirety prior to the execution of a respective software application by the computing device. Alternatively, portions of the software program code/instructions and data can be obtained dynamically, e.g., just in time, when needed for execution. Alternatively, some combination of these ways may be used for obtaining the software program code/instructions and data may occur. As an example, for different applications, components, programs, objects, modules, routines or other sequences of instructions or organization of sequences of instructions. Thus, it is not required that the data and instructions be on a single machine readable medium in entirety at any particular instant of time or at any instant of time ever.

In general, a tangible machine readable medium can include any tangible mechanism that provides (i.e., stores) information in a form accessible by a machine (e.g., a computing device), which may be included, e.g., in a communication device, a network device, a personal digital assistant, a mobile communication device, whether or not able to download and run applications from the communication network, such as the Internet, e.g., an iPhone, Blackberry, Droid or the like, a manufacturing tool, or any other device including a computing device, comprising, e.g., one or more data processors, etc. In an embodiment(s), a user terminal can be a computing device, such as in the form of or included within a PDA, a cellular phone, a notebook computer, a personal desktop computer, etc. Alternatively, any traditional communication client(s) may be used in some embodiments of the disclosed subject matter. While some embodiments of the disclosed subject matter have been described in the context of fully functioning computing devices and computing systems, those skilled in the art will appreciate that various embodiments of the disclosed subject matter are capable of being distributed, e.g., as a system, method and/or software program product in a variety of forms and are capable of being applied regardless of the particular type of computing device machine or machine readable media used to actually effect the distribution.

The disclosed subject matter may be described with reference to block diagrams and operational illustrations or methods and devices to provide the system(s) and/or method(s) according to the disclosed subject matter. It will be understood that each block of a block diagram or other operational illustration (herein collectively, “block diagram”), and combination of blocks in a block diagram, can be implemented by means of analog or digital hardware and computer program instructions. These computing device software program code/instructions can be provided to the computing device such that the instructions, when executed by the computing device, e.g., on a processor within the computing device or other data processing apparatus, the program software code/instructions cause the computing device to perform functions, functionalities and operations of the system(s) and/or method(s) according to the disclosed subject matter, as recited in the accompanying claims, with such functions, functionalities and operations specified in the block diagram.

It will be understood that in some possible alternate implementations, the function, functionalities and operations noted in the blocks of a block diagram may occur out of the order noted in the block diagram. For example, the function noted in two blocks shown in succession can in fact be executed substantially concurrently or the functions noted in blocks can sometimes be executed in the reverse order, depending upon the function, functionalities and operations involved. Therefore, the embodiments of the system(s) and/or method(s) presented and described as a flowchart(s) in the form of a block diagram in the present application are provided by way of example only, and in order to provide a more complete understanding of the disclosed subject matter. The disclosed flow and concomitantly the method(s) performed as recited in the accompanying claims are not limited to the functions, functionalities and operations illustrated in the block diagram(s) and/or logical flow(s) presented in in the disclosed subject matter. Alternative embodiments are contemplated in which the order of the various functions, functionalities and operations may be altered and in which sub-operations described as being part of a larger operation may be performed independently or performed differently than illustrated or not performed at all.

Although some of the drawings may illustrate a number of operations in a particular order, functions, functionalities and/or operations which are not now known to be order dependent, or become understood to not be order dependent, may be reordered. Other functions, functionalities and/or operations may be combined or broken out. While some reordering or other groupings may have been specifically mentioned in the present application, others will be or may become apparent to those of ordinary skill in the art and so the disclosed subject matter does not present an exhaustive list of alternatives. It should also be recognized that the aspects of the disclosed subject matter may be implemented in parallel or seriatim in hardware, firmware, software or any combination(s) of these, co-located or remotely located, at least in part, from each other, e.g., in arrays or networks of computing devices, over interconnected networks, including the Internet, and the like.

The disclosed subject matter is described in the present application with reference to one or more specific exemplary embodiments thereof. Such embodiments are provided by way of example only. It will be evident that various modifications may be made to the disclosed subject matter without departing from the broader spirit and scope of the disclosed subject matter as set forth in the appended claims. The specification and drawings are, accordingly, to be regarded in an illustrative sense for explanation of aspects of the disclosed subject matter rather than a restrictive or limiting sense. Numerous variations, changes, and substitutions will now occur to those skilled in the art without departing from the disclosed subject matter. It should be understood that various alternatives to the embodiments of the disclosed subject matter described as part of the disclosed subject matter may be employed in practicing the disclosed subject matter. It is intended that the following claims define the scope of the disclosed subject matter and that methods and structures within the scope of these claims and their equivalents be covered by the following claims.

What is claimed is:

1. A virtual world reward redemption system comprising:
a user computing device configured to display a virtual world interactive video game environment, the virtual world interactive video game environment including a display of a video game, the display of the video game including a prompt to the user indicating the availability of a virtual game item to the user as a reward for the user taking an action in the real world of the user with respect to at least one of purchasing a product or the performance of a service;
a user interface configured for the user to verify the taking of the action by the user in the real world of the user through the capture of a video feed by the user computing device of a proof of purchase item and transmitting the video feed through the user computing device; and
the user computing device configured to receive confirmation of the user taking the action of the user in the real world of the user in the form of a redemption by the user of the virtual game item.

2. The virtual world reward redemption system of claim 1 further comprising:
the user computing device comprising a hand held user computing device.

3. The virtual world reward redemption system of claim 1 further comprising:
the video game comprising a role playing game.

4. The virtual world reward redemption system of claim 1 further comprising:
the prompt indicating to the user at least one of the virtual game item and the action to be taken by the user in the real world of the user.

5. The virtual world reward redemption system of claim 1 further comprising:
the user interface comprising a digital camera contained on a hand held user computing device.

6. The virtual world reward redemption system of claim 2 further comprising:
the data collection unit comprising a digital camera on the hand held user computing device.

7. The virtual world reward redemption system of claim 1 further comprising:
the action in the real world of the user comprising the user, without a prompt, selecting a product or the performance of a service and the user computing device configured to verify the user taking an action with respect to the user selected product or user selected performance of a service.

8. The virtual world reward redemption system of claim 2 further comprising:
the user computing device configured to utilize a video recognition algorithm for the confirmation of the user performing the action of the user in the real world of the user.

9. A virtual world reward redemption method comprising:
displaying via a user computing device a virtual world interactive video game environment, the virtual world interactive video game environment including a display of a video game;
providing a prompt to the user within the display of the video game environment indicating the availability of a virtual game item to the user as a reward for the user taking an action in the real world of the user with respect to at least one of purchasing a product or the performance of a service;
verifying, via a user interface, the user taking of the action in the real world of the user through the capture of a video feed with the user computing device of a proof of purchase item; and
receiving, via the user computing device, confirmation of the user taking the action of the user in the real world of the user in the form of a redemption by the user of the virtual game item.

10. The virtual world reward redemption method of claim 10 further comprising:
the user computing device comprising a hand held user computing device.

11. The virtual world reward redemption method of claim 10 further comprising:
the video game comprising a role playing game.

12. The virtual world reward redemption method of claim 10 further comprising:
the prompt indicating to the user at least one of the virtual game item and the action to be taken by the user in the real world of the user.

13. The virtual world reward redemption method of claim 9 further comprising:
the user interface comprising a digital camera contained on a hand held user computing device.

14. The virtual world reward redemption method of claim 10 further comprising:
the data collection unit comprising a digital camera on the hand held user computing device.

15. The virtual world reward redemption method of claim 9 further comprising:
the action in the real world of the user comprising the user, without a prompt, selecting a product or the performance of a service and verifying, via the user computing device, the user taking an action with respect to the user selected product or user selected performance of a service.

16. A machine readable medium storing instructions that, when executed on a computing device, cause the computing device to perform a method, the method comprising:
displaying a virtual world interactive video game environment, the virtual world interactive video game environment including a display of a video game;
providing a prompt to the user within the display of the video game environment indicating the availability of a virtual game item to the user as a reward for the user taking an action in the real world of the user with respect to at least one of purchasing a product or the performance of a service;
verifying the user taking the action in the real world of the user through the capture of a video feed using the user computing device of a proof of purchase item and transmitting the photograph through the user computing device; and
receiving confirmation of the user taking the action of the user in the real world of the user in the form of a redemption by the user of the virtual game item.

17. The machine readable medium of claim 16, the method further comprising:
the user computing device comprising a hand held user computing device.

18. The machine readable medium of claim 16, the method further comprising:
the video game comprising a role playing game.

19. The machine readable medium of claim 16, the method further comprising:
the prompt indicating to the user at least one of the virtual game item and the action to be taken by the user in the real world of the user.

20. The machine readable medium of claim 16, the method further comprising:
the user interface comprising a digital camera contained on a hand held user computing device.
